(19) United States
(12) Patent Application Publication
(10) Pub. No.: US 2005/0052824 A1
(43) Pub. Date: Mar. 10, 2005

(54) Method of producing electric power generating element and cell using volcanic ash, cell using volcanic ash, and aparatus for controlling cells

(76) Inventors: Masanori Jyoya, Kitamatsuura-gun (JP); Toshio Kikkawa, Matsudo-shi (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/487,988

(22) PCT Filed: Aug. 28, 2002
(86) PCT No.: PCT/JP02/08674

(30) Foreign Application Priority Data
Aug. 28, 2001 (JP) PCTJP0107384

(51) Int. Cl. H01G 4/08

(52) U.S. Cl. 361/321.5

(57) ABSTRACT

The present invention provides a zero-emission electric power generating element using volcanic ash which is needless to treat waste batteries and is capable of regenerating electric energy and further provides an apparatus for controlling a group of batteries formed by the elements while seeking the best use of static electricity of volcanic ash. According to the present invention, a static electricity generating member (17b) comprising fine hollow powder (10a) made out of volcanic ash (10), other mineral ores (11c) and activated mineral water (11b) containing minus ion and a electrically conductive wet pulverulent body (30) comprising active carbon, fullerene or nanotube are filled into a insulative and sealable cylindrical container (31). The filled container is capped with an anode (15a) and a cathode (15b) and sealed so as to prevent gas or moisture from permeating.

### FIELD OF THE INVENTION

The present invention relates to a method of Producing electric power generating element using volcanic ash and minus ion solution capable of generating electromotive force, a cell produced by said method and an apparatus for controlling the cells.

### PRIOR ART

Cylinder or button type dry batteries have been used for power sources for various electric appliances. Chemical reagents are used for electrolytes in these batteries. Electromotive reactions of the electrolytes generate electromotive force.

As mercury-free dry batteries have been desired for a long time, mercury-free batteries were brought to realization by developing corrosion-resistant zinc alloys, specific corrosion resistant reagents or new type separators in the case of an alkaline-manganese dry battery. Successful development of button type air dry battery as a substitute of mercury battery for a hearing aid put an end to the production of mercury batteries.

Meanwhile, when dry batteries such as cylinder or button type batteries are used up, the disposal of batteries waste becomes a social problem as the waste contains chemicals. Further, the waste is unable to recover to be reused.

Problems to be solved on which special emphasis is laid are reuse of natural source by recovery and recycling of waste batteries, developing of more clean new batteries and discovery of new materials in order to realize a clean life environment or global environment.

### SUMMARY OF THE INVENTION

In view of the aforementioned problems, the object of the present invention is to provide a zero-emission electric power generating element using volcanic ash which is needless to treat waste batteries and capable of regenerating electric energy and to provide an apparatus for controlling a group of batteries formed by the elements and further to seek the best use of static electricity of volcanic ash.

According to a first aspect of the present invention, a method of producing an electric power generating element using volcanic ash wherein said element is composed of a static electricity generating member formed out of volcanic ash dampened with a minus ion aqueous solution, and an anode and a cathode sandwiching said member.

The first aspect of the present invention describes essential configurations of an electric power generating element using volcanic ash.

Volcanic ash erupts from volcanoes and forms an amorphous clay mineral, allophane. The attention is directed to the ion exchange property of allophane.

A static electricity generating member which efficiently and continuously generates static electricity to generate electromotive force is formed by impregnating a secondary deposit, which has a plenty of static electricity above all the volcanic ashes, with an appropriate amount of minus ion aqueous solution. The electric power generating element comprises the static electricity generating member, an anode and a cathode which take the static electricity out as an electromotive force.

In this connection, the volcanic ash is used in various health goods and has effect to purify environment. Therefore, treatment of the wasted electric power generating elements does not contain causes of environmental pollution.

According to the first aspect of the present invention, in the method of producing an electric power generating element using volcanic ash, a static electricity generating member preferably is a clay form produced by kneading hollow volcanic ash particles (balloon shaped particles) with an appropriate amount of minus ion aqueous solution, hollow volcanic ash particles being formed by treating volcanic ash particles.

The above invention describes essential configurations of a static electricity generating member. Secondary deposit of volcanic ash is pulverized to fine particles which is converted to hollow particles by high temperature treatment; an appropriate amount of the minus ion aqueous solution is added to the hollow particles to form clay which is molded to a prescribed water retainable form to form a battery material.

Electro conductivity of lamination is enhanced by the molding because of a good fitness of the material inserted between the anode and the cathode.

According to the first aspect of the present invention, in the method of producing an electric power generating element using volcanic ash, another static electricity generating member may be formed by adding the minus ion aqueous solution to an unglazed board form molded matter made of volcanic ash.

The above invention describes essential configurations of another static electricity generating member. Secondary deposit of volcanic ash is pulverized to fine particles which is converted to hollow particles by high temperature treatment; an unglazed board form molded matter is made of the hollow particles to which an appropriate amount of the minus ion aqueous solution is added and impregnated.

According to the first aspect of the present invention, in the method of producing an electric power generating element using volcanic ash, it is preferable to form an electric power generating element by inserting a cathode and an anode into a static electricity generating member having the clay form.

The static electricity generating member has a plurality of inserted needle shaped cathodes and anodes into the static electricity generating member having a form of clay, which enables to miniaturize the electric power generating element.

According to the first aspect of the present invention, in the method of producing an electric power generating element using volcanic ash, it is preferable that an anode has an electrically conductive pulverulent body containing water on the side contacting a static electricity generating member.

The above invention describes another method of producing an electric power generating member comprising sandwiching an electrically conductive pulverulent body containing water between an anode and volcanic ash containing minus ion solution in an electric power generating element which is formed by sandwiching volcanic ash between a cathode and an anode in order to obtain an effective electric power generating element by increasing electrical conductivity of static electricity generated in the volcanic ash containing minus ion solution.

In another method of producing an electric power generating element according to the first aspect of the present invention, the electrically conductive pulverulent body containing water preferably comprises active carbon, fullerene or nanotube, or a mixture thereof.

In a method of producing an electric power generating element according to the first aspect of the present invention, the static electricity generating member is preferably made of a mixture of volcanic ash and other mineral ores to form the electric power generating element.

The above invention describes another configuration of a static electricity generating member comprising volcanic ash containing minus ion solution (hereinafter referred to as wet volcanic ash) wherein volcanic ash is blended with other mineral ores.

Other mineral ores are preferably tourmaline, quartz, diatomaceous earth or zeolite.

In a method of producing an electric power generating element using volcanic ash according to the first aspect of the present invention, a member used as a cathode or an anode is preferably a plate of nickel, gold, silver, aluminum, or P- or N-type silicon.

These cathodes and anodes preferably contain corrosion inhibitor.

In a method of producing an electric power generating element using volcanic ash according to the first aspect of the present invention, cathodes and anodes have means for detecting polarity thereof whereby detecting their polarity in the case of forming a group of small electric power generating elements is made accurately.

In a method of producing an electric power generating element using volcanic ash according to the first aspect of the present invention, minus ion solution to be impregnated in volcanic ash is preferably an activated mineral water having minus ion.

For example, a unit cell electric power generating element is prepared by galvanizing a cylindrical iron container of the diameter of 10 mm and the height of 7 mm with zinc metal to make a cathode, filling volcanic ash soaked with the minus ion aqueous solution (activated mineral water), and inserting an anode into the middle thereof. The terminal voltage of 1.25 volts is detected for a unit cell. When the anode and the cathode are connected externally through a load resistance of 1000 ohm to flow the current, the initial terminal voltage of 1.1 volts gradually lowers ton 0.8 volts for 10 minutes.

However, when stopping the current, the voltage of the cell gradually increases to approximately 1.15 volts after 10 minutes; thus the cell has a property of recovering the electromotive force.

According to the first aspect of the present invention, in the method of producing an electric power generating element using volcanic ash in various cases such as in the case of using volcanic ash alone, in the case of using a mixture of volcanic ash and other mineral ores, or in the case of contacting anode with electrically conductive wet pulverulent body containing minus ion solution, the electric power generating element preferably has an insulative container and has a sealed construction with a cathode and an anode located in the both end of the container.

The electric power generating element of the present invention is composed so as to obtain the durability whereby preventing water and gas produced by respiration action when generating static electricity from escaping out of the container.

In the above invention, the sealed construction is preferably a moisture proof construction preventing permeation of water and gas.

According to a second aspect of the present invention concerning a cell having a configuration which is appropriate for application to an external load of the electric power generating element prepared by the method of producing an electric power generating element using volcanic ash according to the first aspect of the present invention, in an electric power generating elements in the case of comprising a static electricity generating member, and an anode and a cathode between which said member is sandwiched, wherein the static electricity generating member comprising a member made of volcanic ash with minus ion aqueous solution impregnated or in the case using a static electricity generating member using a mixture of volcanic ash and mineral ores or in the case of contacting an anode with electrically conductive wet pulverulent body or in the case of having sealed construction with a cathode and an anode, a group of electric power generating members is formed by wiring a plurality of the elements in accordance with a prescribed voltage and current capacity and thus formed group of the elements is disposed on an external connecting terminal board for connecting to an external load.

The second aspect of the invention described above concerns a configuration which is appropriate for application to an external load of a group of the electric power generating elements prepared by the method of producing an electric power generating element using volcanic ash according to the first aspect of the present invention. According to the above second invention, a cell construction for utilizing static electricity of volcanic ash which forms electromotive force that enables to flow electric current a little and for a short time and enables to flow electric current again at a short period after stop of current using volcanic ash is described wherein the power generating elements are integrated for supplying electric power to an external load and a connecting means is provided for connecting integrated electrode terminals of small elements to an external load.

In a configuration of the cell using volcanic ash according to a second aspect of the present invention, a group of elements preferably have a multi-layer construction and external connecting terminal boards at electrodes of the elements of upper and lower end of series connection for connecting to an external load.

The above invention describes the configuration for obtaining a high voltage cell for an external load wherein unit elements each of which comprises an anode, an electrically conductive wet pulverulent body, volcanic ash containing water and cathode are stacked to a multi-layer and connected in series and a group of the stacked elements has external connecting terminals to connect to an external load at the anode and the cathode of upper and lower end layer.

According to the above invention, the multi-layer structure preferably comprises cathodes having protruded parts and anodes having recessed parts which fit to the protruded parts wherein each layer of elements is engaged to another layer of elements with the protruded parts and the recessed parts when stacked so as to prevent from deteriorating seal construction. Misalignment between elements of an upper layer and elements of a lower layer is perfectly avoided by the fitting structure of electrodes; thereby seal construction of elements by the container is not deteriorated.

In the configuration of the cell using volcanic ash according to the second aspect of the present invention, a group of electric power generating elements preferably constructed in such a manner that different electrodes of different elements are serially connected and external connecting terminal boards are provided at the unconnected anode and cathode of the elements of upper and lower end of series connection.

The above invention is described for constructing the cell for a high voltage load consisting of electric power generating elements according to the first aspect of the present invention wherein a high voltage is obtained by connecting serially cathodes to anodes of a plurality of groups of elements.

In the configuration of the cell using volcanic ash according to the second aspect of the present invention, a group of elements preferably constructed in such a manner that electrodes of the same polarity of different elements are connected in parallel and external connecting terminal boards are provided at the connecting ends in order to apply for high current load by means of parallel connection. In a configuration of the cell using volcanic ash according to a second aspect of the present invention, a group of elements preferably constructed in such a manner that cathodes and anodes of elements are connected serially and in parallel and external connecting terminal boards are provided at the connecting ends wherein appropriate number of elements are connected in parallel and a plurality of groups of the elements thus connected in parallel are serially connected in order to apply for a voltage and current of an external load.

According to a third aspect of the present invention concerning a cell having a construction which is appropriate for application to an external load of the electric power generating element prepared by the method of producing an electric power generating element using volcanic ash according to the first aspect of the present invention, a cell comprises an insulation container board having small holes, electric power generating elements, and terminal boards for external connection, said electric power generating elements being encapsulated into the small holes of said insulation container board to compose an electric power generating board, a group of anodes and a group of cathodes that are exposed on the upside and downside surface of the electric power generating board being connected together or separately to said terminal boards for external connection.

Two groups, three groups or multi groups of electric power generating boards can be connected by means of the above external connecting terminal boards.

In the third aspect of the invention, it is preferable that the container board has small holes into which volcanic ash containing minus ion solution and electrically conductive pulverulent body containing water are filled; anodes and cathodes are hermetically attached at the both ends of the filled holes to form an electric power generating board having a unit layer cell.

In the above invention, electric power generating elements hermetically disposed into many holes of the container board are connected in parallel with the terminal board to form an electric power generating board having a unit layer cell.

In the third aspect of the invention, it is preferable that the container board has small holes into which volcanic ash containing minus ion solution and electrically conductive pulverulent body containing water are filled; anodes and cathodes are hermetically attached at the both ends of the filled holes to form a unit layer cell; and an electric power generating board is formed by stacking a plurality of unit layer cells wherein the cathodes have protruded parts and anodes have recessed parts which are fit to the protruded parts and each electric power generating board is engaged to another electric power generating board with the protruded parts and the recessed parts.

In the case of the above invention, a plurality of unit layer cells are prepared and stacked serially so as to increase output voltage in accordance with stacked number of unit layer cells.

In the third aspect of the invention, a container board preferably has a thickness of n time the thickness of an unit layer cell minus a thickness of a cathode and an anode and has a plurality of arrayed holes. An electric power generating board is constructed preferably in such a manner that every hole is filled with a n-layer elements built serially and the both ends of the hole are hermetically sealed with a cathode and an anode of the end elements. More particularly, a cutout member having a layer of element is prepared by coating volcanic ash containing minus ion solution on a cathode sheet, then coating electrically conductive wet pulverulent body thereon and finally laminating an anode sheet on it. N seats of the member having a layer of element (cut-out member) are stacked and cut out so as to fit the hole while the cut out n-layer elements is mounted in the hole. Both ends of the hole are hermetically sealed with a cathode and an anode of each element.

In the case of the above invention, a thickness of a container board is n times the thickness of an unit layer unit layer element minus a thickness of an end cathode and an end anode and small holes of the container board are mounted serially with the n times of electric power generating element and both ends of holes are hermetically sealed with cathodes and anodes.

N pieces of cut-out member comprising a cathode sheet and an anode sheet of the approximately the same size as the container board, a cathode and an anode, and a coated layer of volcanic ash containing water and a coated layer of electrically conductive wet pulverulent body therebetween are prepared for the above mounting.

Arrayed holes are provided on to the container board. A cutout die having the same arrangement as the arrayed holes and for cutting out cylindrical blanks of the same size as the hole is prepared.

Since the cylindrical blanks are filled into all of the arrayed holes of the container board at the same time of cutting-out, n pieces of elements are serially filled with pressure on to the container board by an operation of cutting-out, which results in forming an electric power generating board having n-layer elements.

Thus, the above electric power generating board has groups of the power generating elements having n time the output voltage of the unit layer cell as many as a number of small holes. When the small holes are divided into groups, a group having m holes, and external connecting terminal boards are provided, the board being connected to electrodes of m holes, a electric power generating body having n time the output voltage of an unit layer cell and m time the output current of an unit layer cell can be formed.

In the third aspect of the invention, the container board has preferably very small holes provided on the board of a unit thickness. The very small holes are filled with volcanic ash containing minus ion solution and electrically conductive pulverulent body. A cathode is hermetically attached to the lower end of the filled hole and an anode is hermetically attached to the upper end.

According to the above invention, a small electric power generating body is formed using the container board.

According to a forth aspect of the present invention, an apparatus for controlling volcanic ash cells in an electric energy supplying system, which enables to continuously supply electrical energy to a load by switching sequentially a plurality of cells using volcanic ash formed by the second or the third aspect of the present invention comprises a means for switching the connection between a plurality of cells and a load, the cell being formed by an power generation element or a plurality of power generation elements, the element having a static electricity generating member comprising an anode, cathode and volcanic ash impregnated with minus ion solution and being sandwiched by the anode and the cathode wherein every time an output voltage of a connected group of cells decreases to or under a prescribed value, the connection is switched to another group of cells to supply a stable electric energy to the load and number of the groups of cells are set so as to be able to maintain a period of time for recovering an electromotive force of the group of cells which is cut the connection by switching.

The above invention describes the fourth of the apparatus for controlling volcanic ash cells in an electric energy supplying system. In the embodiment, a plurality of cells, each cell comprising a plurality of the power generation elements having the static electricity generating members, are prepared and are switched sequentially to a load to supply continuously a stable electric energy.

Hence, the means for switching the connection of each group of the cells for discharge through a load is provided. Every time the detected voltage of the discharging group of cells decreases to or under a prescribed value, the connection is switched to another group of cells to supply a stable electric energy to the load and number of the groups of cells are provided in order to switch the connection sequentially so as to be able to maintain a period of time for recovering an electromotive force of the group of cells stopped to discharge while the discharge stop period.

As for the means for switching the connection of each group of the cells for discharge through a load, it is also preferable that a plurality of groups of cells are switched periodically on and off sequentially repeatedly without detecting the output voltage of the cells being in use.

The on off switching of a plurality of cells may be conducted by action of a signal generator through a clock pulse of an oscillator provided separately.

According to another aspect of the apparatus for controlling a plurality of volcanic ash cells, the apparatus for controlling the volcanic ash cell comprises an output circuit having a switching controlling device for switching at least three groups of cells wherein a charge discharge circuit having a condenser is provided at the output terminal of the circuit in order to charge and discharge in accordance with a state of load and each voltage of cell is output in pulse by connecting a plurality of cells to a load by switching with a switching signal for load through a switching circuit board at a definite time interval.

The above invention concerns a control device for switching output power of at least three groups of cells of at least three groups. The switching device have a condenser for a buffer at the output terminal and a switching circuit which activates by automatic operation of volcanic ash cells whereby switching output power of a plurality of cells of at least three groups by sending a switching signal from the circuit.

The switching signal for a load is preferably variable with regard to a pulse width.

The above invention is a measure for a case of different output power capacity of volcanic ash cells which supplies electric energy to an external load where time period of power supplying by a pulse width is set to an appropriate value.

The switching circuit board preferably have a power source of a separately prepared group of volcanic ash cells which are switched by switching gate signal.

### BRIEF DESCRIPTION OF DRAWINGS

In the accompanying drawings:

FIG. 1 is a block diagram showing a schematic constitution of an electric power generating element using volcanic ash according to an embodiment of the present invention;

FIG. 2 is a pattern diagram showing a schematic constitution of another embodiment of the present invention;

FIG. 3 is a drawing showing one configuration of a cell formed with electric power generating elements shown in FIG. 2;

FIG. 4 is a drawing showing one configuration of a big current cell formed with electric power generating elements shown in FIG. 2;

FIG. 5 is a drawing showing a production process of a n-layer electric power generating board having a high voltage and high current cell serially connected in multi-layer;

FIG. 6 is a drawing showing a schematic constitution of an electric energy supplying system of cells using volcanic ash;

FIG. 7 is a drawing showing a schematic constitution of an apparatus for controlling an electric energy supplying system by switching cells of FIG. 6 by detecting output voltage;

FIG. 8 is a drawing showing a schematic constitution of an apparatus for controlling an electric energy supplying system by switching cells of FIG. 6 periodically; and

FIG. 9 is a drawing showing another constitution of FIG. 8.

### DETAILED DESCRIPTION OF PREFERRED EMBODIMENTS

The invention will now be described below in detail by way of example with reference to the accompanying drawings. It should be understood, however, that the description herein of specific embodiments such as to the dimensions, the kinds of material, the configurations and the relative disposals of the elemental parts and the like is not intended to limit the invention to the particular forms disclosed but the intention is to disclose for the sake of example unless otherwise specifically described.

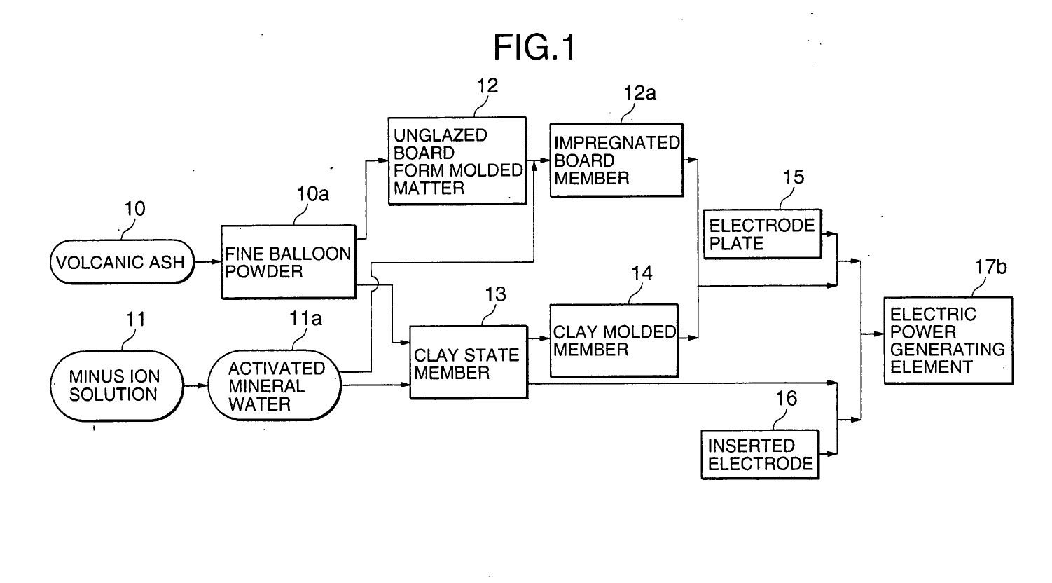

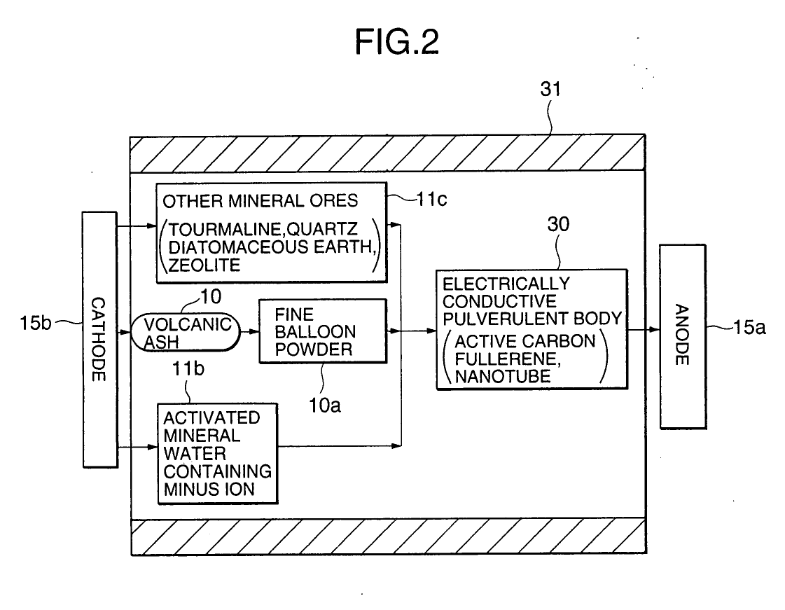

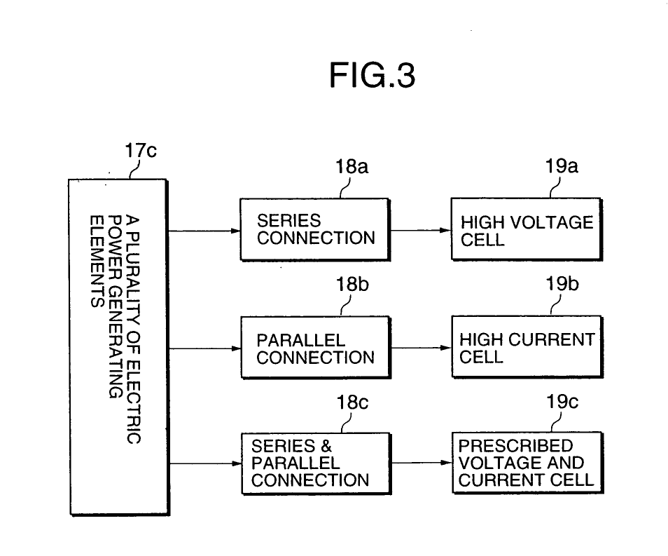

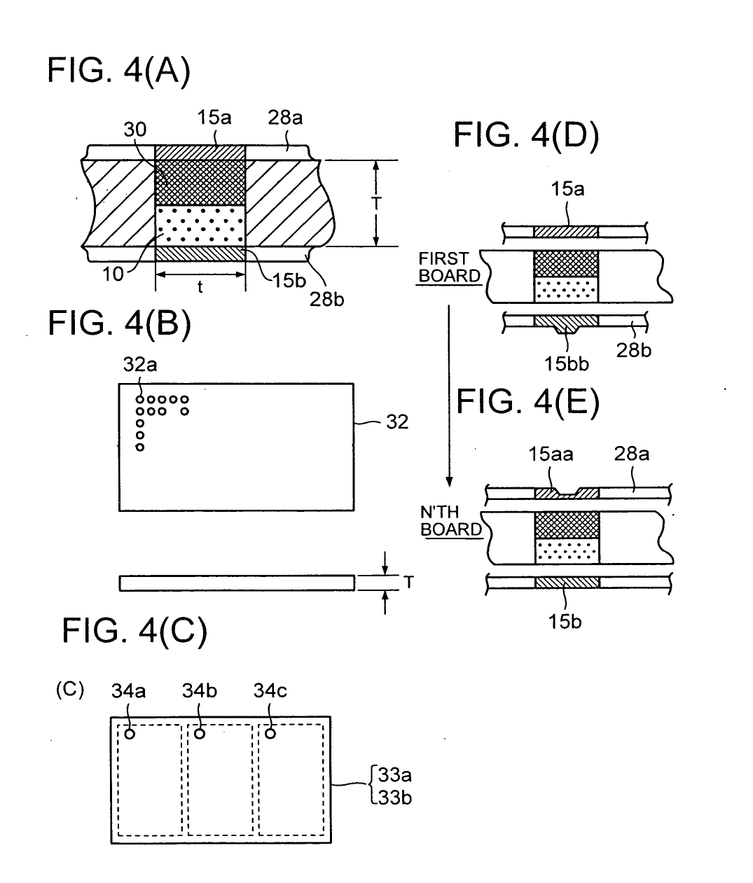

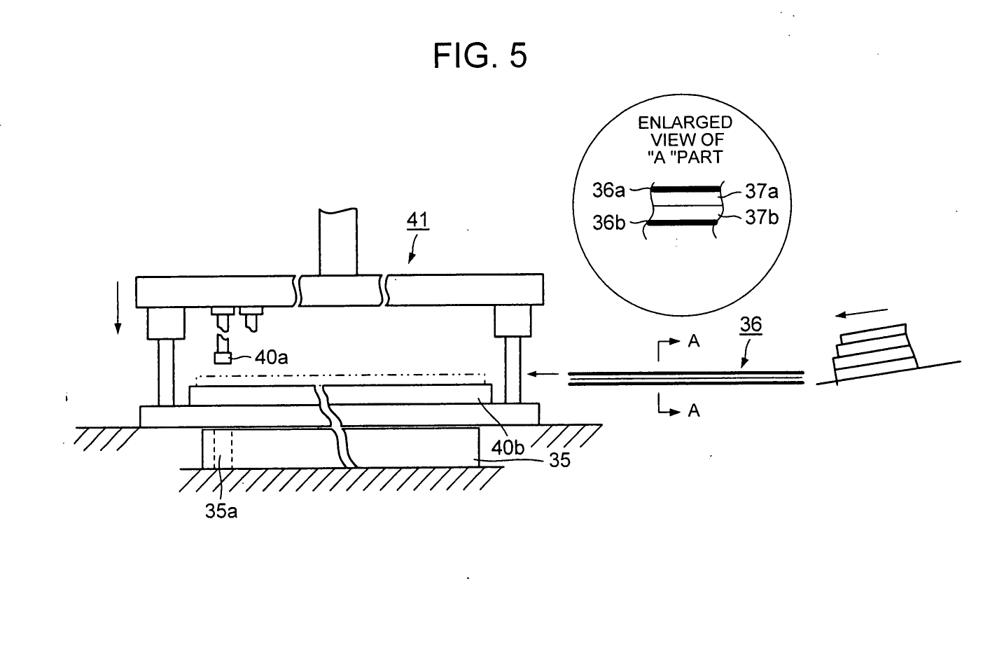

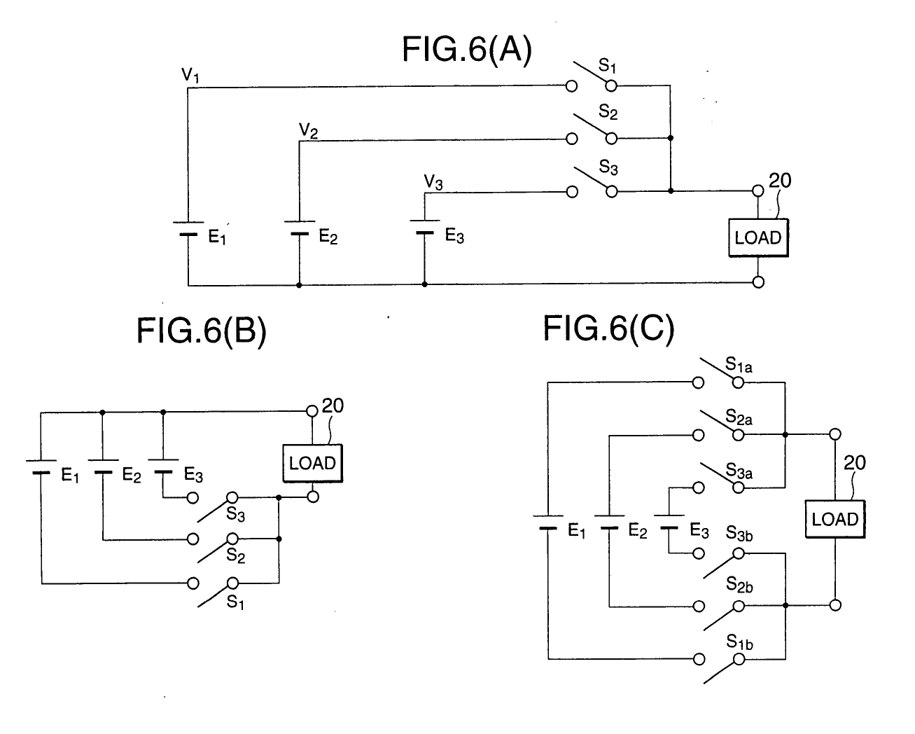

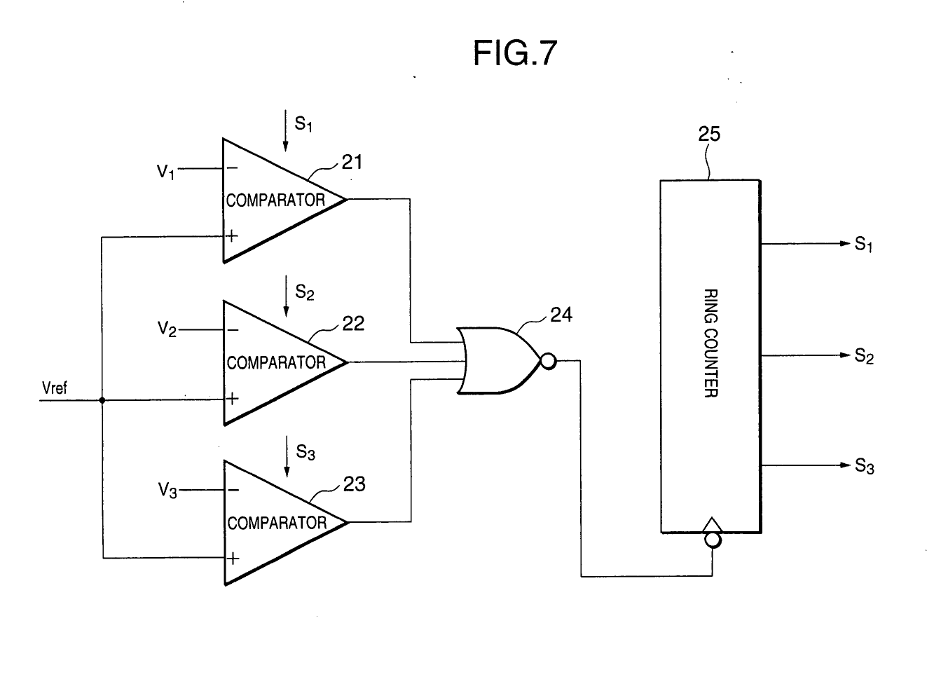

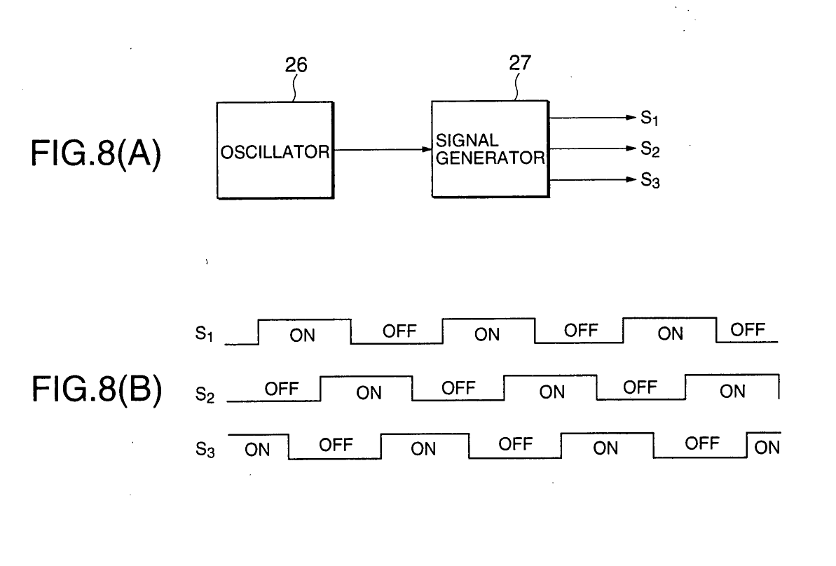

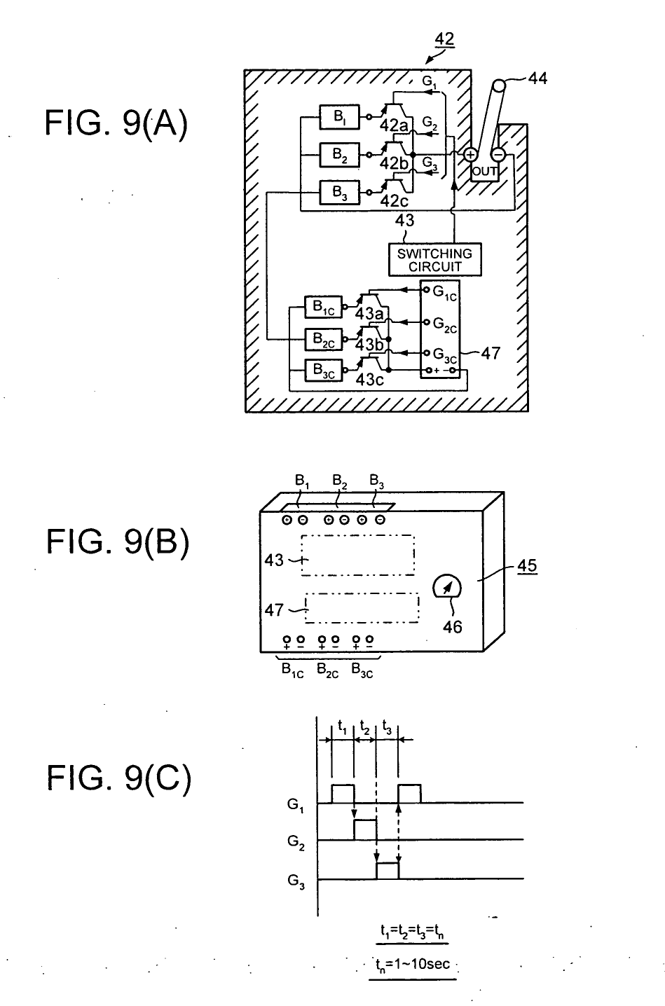

FIG. 1 is a block diagram showing a schematic constitution of an electric power generating element using volcanic ash according to an embodiment of the present invention. FIG. 2 is a pattern diagram showing a schematic constitution of another embodiment of the present invention; FIG. 3 is a drawing showing one configuration of a cell formed with electric power generating elements shown in FIG. 2; FIG. 4 is a drawing showing one configuration of a big current cell formed with electric power generating elements shown in FIG. 2; FIG. 5 is a drawing showing a production process of a n-layer electric power generating board having a big voltage and big current cell serially connected in multi-layer; FIG. 6 is a drawing showing a schematic constitution of an electric energy supplying system of cells using volcanic ash; FIG. 7 is a drawing showing a schematic constitution of an apparatus for controlling an electric energy supplying system by switching cells of FIG. 6 by detecting output voltage; FIG. 8 is a drawing showing a schematic constitution of an apparatus for controlling an electric energy supplying system by switching cells of FIG. 6 periodically; and FIG. 9 is a drawing showing another constitution of FIG. 8.

As shown in FIG. 1, an electric power generating element 17b according to the present invention is formed as follows.

Volcanic ash 10 is pulverized by a mil or the like to fine powder which is then heated to blow for making fine hollow sphere powder 10a of hollow spheres.

The unglazed board form molded matter 12 is made by heating the fine hollow powder 10a at from about 580° C., where the material of the fine hollow powder begins to change, to 1150° C., where the fine hollow powder sinters.

The unglazed board form molded matter 12 is impregnated with the activated mineral water 11a obtained from the minus ion aqueous solution 11 by an apparatus for producing activated mineral water to form a board form impregnated member 12a of a static electricity generating member.

Alternatively, a clay state member 13 is prepared by kneading fine hollow powder 10a with the appropriate amount of activated mineral water 11a; then the clay state member 13 is formed to a clay mold member 14 of a static electricity generating member.

The obtained board form impregnated member 12a or clay mold member 14 as mentioned above is combined with board form electrodes 15 of cathode and anode to form an electric power generating elements 17b.

The clay state member 13 is directly combined with inserted electrodes 16, which are prepared for a cathode and an anode, to form an electric power generating elements 17b.

The existence of static electricity is noticed on the fine hollow powder 10a in the above process of forming the electric power generating element 17b. For example, voltage generation of 0.45-0.75 volts is noticed when an electric signal is detected between a cathode and an anode having fine powder of the volcanic ash between them. Further in this state, when the load resistance of 1000 ohms is connected at both ends of the cathode and anode, the voltage turns to approximately zero. With this phenomenon, it is verified that fine powder of the volcanic ash has static electricity.

By adding activated mineral water 11a to fine hollow powder 10a or impregnating fine hollow powder 10a with activated mineral water 11a, insertion of ion is permitted; the insertion gives electromotive force to the static electricity, thereby electric energy can be drawn to the outside.

Thus, as for the method of drawing the static electricity of the fine hollow powder 10a prepared from the volcanic ash 10 as a dynamic electricity, that is an electromotive force, use of the activated mineral water is proved to be effective.

For example, an iron plate plated with zinc is prepared as a cathode and a cupper plate as an anode. A clay state member prepared by impregnating volcanic ash with activated mineral water containing minus ion is put between the cathode and anode. Then the voltage and current are detected between the electrodes. A voltage equal to or over 1 volt is observed and an electric signal of 0.5 volts and 0.5 mlliamperes can be detected at the both end of the resistance of 1000 ohms connected between the cathode and anode. It is proven that electric energy is able to be drawn.

Preparing a lot of cathodes and anodes, applying a lot of insert electrodes 16 to the clay state member 13 for example, high voltage or high current of electric energy is possible.

The voltage of 0.949 volts and the current of 2.14 milliamperes, that is electric energy of about 2 milliwatts can be drawn when a resistance of 450 ohms is connected between the cathode consisting of 290 pieces of 0.5 mmφ zinc plated wire and the anode consisting of needle-like insert electrodes of 409 pieces anode of 0.8 mmφ cupper wire.

When a resistance between the anode and the cathode is changed to 150 ohms, a voltage of 0.779 volts and a current of 5.18 milliamperes that is electric energy of about 4 milliwatts can be drawn.

As stated above, no chemical reagent is used but nonpolluting volcanic ash is used in an electric power generating element according to the present invention. Electric charge generated by the element varies with electrode form and number. Required amount of electric energy can be derived by a way of connection (in series or parallel) of the elements.

For example, a unit of cell is made by preparing a cylindrical iron container having a diameter of 10 mm and a height of 7 mm, plating with zinc on the surface of the container to make a cathode, filling volcanic ash containing minus ion aqueous solution (activated mineral water), and inserting a copper piece in the center part thereof to form an anode. The unit cell has a terminal voltage of 1.25 volts. When a resistance of 1000 ohms is connected between the anode and the cathode, a terminal voltage of about 1.1 volts is detected.

Incidentally, the electromotive force of the electric power generating element in which volcanic ash is used lowers after a short time when used by flowing the current. For example, when a resistance of 1000 ohms is connected between the anode and the cathode of the unit cell to flow current, the terminal voltage of 1.1 volts gradually lowers to 0.8 volts after about 10 minutes.

However, when stopping the current, the voltage of the cell gradually increases to approximately 1.15 volts after 10 minutes; thus the cell has a property of recovering the electromotive force.

FIG. 2 is a pattern diagram showing a schematic constitution of another embodiment of the present invention.

In this case, a static electricity generating member comprising fine hollow powder 10a prepared from volcanic ash 10 shown in FIG. 1, other mineral ores 11c and activated mineral water 11b containing minus ion and a electrically conductive wet pulverulent body 30 comprising active carbon, fullerene, nanotube or the like are filled into a insulative and sealable cylindrical container 31. The filled container is capped with an anode 15a and a cathode 15b and sealed with a caulking material such as silicone sealant capable of preventing gas or moisture from permeating.

The cylindrical container 31 has an appropriate strength and consists of insulative material distinguished in water retainable property so as to prevent water impregnated in inner mineral ore powder from permeating to outside, initial humidity being kept for 1-2 years. Static electricity generating member comprising volcanic ash 10, fine hollow powder 10a, other ores 11c and active mineral water 11b containing minus ion, and electrically conductive wet pulverulent body 30 comprises powder having a particle size of 7-15 μm containing a small amount of water.

Active carbon, fullerene or nanotube is selected and blended to be used for the electrically conductive wet pulverulent body 30.

As shown in FIG. 2, an element is sealed and isolated in a container 31, so as to effectively utilize electricity generated between cathode 15b and anode 15a.

Generating capacity of an unit element sealed and isolated in a container is irrelevant with respect to the dimension of the element; for example, when a large, medium and small element of following dimensions are compared regarding generated voltage, nearly same voltage of about 1.2 volt is obtained.

A lot of small holes are provided in insulative member. Volcanic ash (fine hollow powder) and electrically conductive pulverulent carbon are filled into the holes. Both ends of filled hole are attached with electrodes to derive electricity, thereby a compact but large capacity cell consisting of electric power generating elements 17b is obtained.

FIG. 3 shows a configuration of a cell consisting of the electric power generating elements 17b.

As shown in FIG. 3, a plurality of the electric power generating elements 17c are constructed so that any cells of 19a, 19b or 19c can be appropriately selected and set by connecting their terminals through a series connection 18a to obtain a high voltage cell 19a, through a parallel connection 18b to obtain a high current cell 19b and through a series and parallel connection 18c to obtain a prescribed voltage and current cell 19c.

FIG. 4(A)-FIG. 4(E) show a configuration of a high current cell consisting of the electric power generating elements 17b.

As shown in FIG. 4(B), a container board 32 is prepared in such a manner that small holes 32a arrayed on right and left and back and front having a diameter of t are disposed on insulative board having a low permeability of gas or moisture of a thickness of T which is as thick as the thickness of the element minus the thickness of the anode and cathode.

Then, as shown in FIG. 4(A) of an enlarged view, volcanic ash containing water 10 and electrically conductive pulverulent body 30 are filled with pressure into each hole 32a at a thickness of about half the thickness of the board and an anode board 28a and a cathode board 28b in which an anode 15a and a cathode 15b are buried are hermetically attached with pressure at upper and lower ends thereof.

As FIG. 4(C) depicts, external connecting boards 33a and 33b are affixed onto the anode board and the cathode board.

The anode board 28a and the cathode board 28b consist of a material having insulative property, appropriate strength and a property to prevent from transpiring water contained in ore powder.

The external connecting boards 33a and 33b have electrically conductive plates on one side of the boards at all surface region or at three divided surface regions which are connected to external terminals 34a, 34b, 34c (in the case of dividing into three regions).

In the case elements buried in the small holes are serially connected by means of stacking a plurality of container boards 32 (e.g. 1-n layers) to form multi layers, as for electrodes on the sides of electrode boards contacting each other, a cathode of for example zinc on a cathode board 28b has a protruded part 15bb and an anode for example copper on an anode board 28a has a recessed part 15aa so as to be fixed by engaging each other when stacked. A cell of high voltage and high current is obtained in this case.

FIG. 5 illustrates a cell of high voltage and high current by connecting in multi series in the same way as FIG. 4(D).

To produce the cell, a die set 41 capable of punching many holes at the same time, an insulative, air tight and water tight container board 35 having a thickness of n time the thickness of an element minus a thickness of an end cathode and an end anode and having a plurality of arrayed holes 35a, n sheets of cut-out member 36 (as shown in the enlarged view of “A” part of FIG. 5) having a cathode 36b and an anode 36a of the same dimension as the container board 35, a coated layer of volcanic ash containing water 37b, a coated layer of electrically conductive wet pulverulent body 37a therebetween are provided beforehand.

When preparing a cell of n-layer elements, a container board 35 is set so as to contact the under surface of the female die 40b of the die set 41. The position of a punch hole of the female die 40b is accurately the same as the position of a small hole 35a of container board 35 by means of a guide.

Then the cutout member 36 is put on to the female die 40b. An electric power generating element of a unit layer cell, which is a cut-out blank, is filled to each small hole 35a of the container board 35 by cut-out operation with a male die 40a. n fold aforementioned cutout operations produce a container board of n-layer cell.

n layers of groups of elements filled and buried are sealed with a cathode of the lower end element and an anode of upper end element, which results in the container board 35 having attached sealed construction.

Finally the external connecting boards 33a, 33b are fixed. FIG. 6(A)-FIG. 6(C), FIG. 7 and FIG. 8 illustrate schematic constitutions of an electric energy supplying system of cells using volcanic ash. An apparatus for controlling an electric energy supplying system capable of supplying stable electric energy to a load by switching to use the above plurality of groups of cells and capable of stabilizing a supply of electric energy by switching repeatedly as many groups of cells as a time period for recovering electromotive force of cells using disuse time can be secured are illustrated.

FIG. 6(A)-FIG. 6(C) show schematic constitution of an electric energy supplying system of the cells formed by groups of electric power generating elements using volcanic ash.

A circuit comprising three cells E₁, E₂, E₃ using volcanic ash and having a terminal voltage of V₁, V₂, V₃ , three switches S₁, S₂, S₃ and a load 20 are depicted in FIGS. 6(A) and 6(B).

At least one cell is connected to a load 20 to supply a stable electric energy in according with a control method hereinafter mentioned of appropriately controlling switches S₁, S₂, S₃.

The above-described switches are electrically realizable with a MOS analog switch or the like.

FIG. 6(C) illustrates a circuit which switches between terminals of three cells and a load 20 using 6 switches S₁ₐ, S_{1b}, S₂ₐ, S_{2b}, S₃ₐ and S_{3b}.

FIG. 7 shows a schematic constitution of one embodiment of an apparatus for controlling for an electric energy supplying system of voltage detecting type switching the groups of cells shown in FIG. 6 by detecting voltage.

As shown in the figure, the apparatus for controlling comprises three comparators 21, 22, 23, a three-input NOR-gate 24 and a ring counter 25. The three comparators are on the state of enable by (S₁, S₂, S₃). And zero is output for the disable period. At the initial state, (S₁, S₂, S₃) is (1, 0, 0). The cell E₁ is on state. When the terminal voltage V₁ of E₁ gradually decreases to become under the reference voltage V_{ref}, the output signal of the comparator 21 is delivered to the clock of the ring counter 25 to convert to (0, 1, 0) wherein E₂ is transferred to on state and E₁ to off state at the same time. And the comparator 22 which S₂ enables is activated. By repetition of the above-described action, stable supply of electric energy is possible.

The aforementioned apparatus for controlling the electric energy supplying system can realize the electric energy supplying system capable of stably supplying electric power as a whole and of recovery effect as well by preparing plural sets of same kind cells used alternately with two ways of on state and off state and enough numbers of groups of cells so as to retain a time period of need for recovery. Another constitution of the control is, apart from the above, to repeat to switch on and off periodically each set of cells without detecting the voltage of the cells.

FIG. 8(A), FIG. 8(B) are schematic constitutional drawings of an apparatus for controlling an electric energy supplying system switching periodically a group of cells shown in FIG. 6. In FIG. 8(A), a signal generator 27 is activated with the output frequency of a oscillator 26 as a clock pulse; and S₁, S₂, and are activated as shown in the time chart of FIG. 8(B) so that one or more cells are on at all period of cycle and each cell has off-current period.

FIG. 9(A)-FIG. 9(C) show a schematic constitution of another apparatus for controlling cells. The apparatus for controlling cells comprises a main switching unit 42 having a switching circuit 43 and a power source battery switching circuit 47, and a charge-discharge circuit comprising a condenser 44, which is housed in a box 45 as shown in FIG. 9(B).

Operating electric power is supplied to switching circuit 43 by switching to activate cells of volcanic ash B_{1c}, B_{2c}, B_{3c} through power transistors 43a, 43b, 43c by gate signals G_{1c}, G_{2c}, G_{3c} generated by a power source battery switching circuit 47. The switching circuit 43 generates a gate signal G₁, G₂, G₃ shown in FIG. 9(C). The signal activates sequentially power transistors 42a, 42b, 42c to switch and activate cells of volcanic ash B₁, B₂, B₃.

A multi digit counter is used for the above gate signals G₁, G₂, G₃. A gate signal G₁ is generated with unshown clock pulse by dynamic output method shown in FIG. 9(C) and followed by a gate signal G₂and G₃.

In this case, t₁=t₂=t₃=tₙ=1-10 sec is set by time adjusting controller 46.

Effects of Invention

According to the above configurations, effects of the present invention are as follows.

Static electricity of volcanic ash can be utilized effectively and in addition, electric power generating elements capable of reproducing electric energy, needless to discard and using zero-emission volcanic ash can be obtained. By preparing two or more sets of groups of cells formed by the power generating elements, the power generating elements can be used as an alternately changeable power source apparatus whereby pollution free and long life power source apparatuses can be provided. Since volcanic ash has an effect for cleaning environment, treatment of wasted power generating elements using volcanic ash does not cause environmental pollution.

1. A method of producing an electric power generating element using volcanic ash wherein said element is composed of a static electricity generating member formed out of volcanic ash dampened with a minus ion aqueous solution, and an anode and a cathode sandwiching said member.

2. The method of producing an electric power generating element using volcanic ash according to claim 1, wherein said static electricity generating member is formed out of volcanic ash treated to be hollow particles added with a proper amount of a minus ion aqueous solution and kneaded into kneaded-clay like state.

3. The method of producing an electric power generating element using volcanic ash according to claim 1, wherein said static electricity generating member is an unglazed plate-like pottery made of volcanic ash impregnated with a minus ion aqueous solution.

4. The method of producing an electric power generating element using volcanic ash according to claim 2, wherein said cathode and anode are inserted into said kneaded-clay like static electricity generating member.

5. The method of producing an electric power generating element using volcanic ash according to claim 1, wherein an electrically conductive powder containing water intervenes between said anode and static electricity generating member.

6. The method of producing an electric power generating element using volcanic ash according to claim 5, wherein said electrically conductive powder containing water comprises active carbon, fullererse, or nanotube.

7. The method of producing a electric power generating element using volcanic ash according to claim 1, wherein a mineral other than the volcanic ash is mixed into said static electricity generating member.

8. The method of producing an electric power generating element using volcanic ash according to claim 7, wherein said mineral comprises tourmaline, quartz, diatomaceous earth, or zeolite.

9. The method of producing an electric power generating element using volcanic ash according to claim 1, wherein said cathode and anode are made of nickel, silver, aluminum, P- or N-type silicon plate.

10. The method of producing an electric power generating element using volcanic ash according to claim 1, wherein said cathode and anode contain corrosion inhibitor.

11. The method of producing an electric power generating element using volcanic ash according to claim 9, wherein said cathode and anode are formed so that their polarity can be recognized.

12. The method of producing an electric power generating element using volcanic ash according to claim 1, wherein said minus ion aqueous solution is an activated mineral water containing minus ion.

13. The method of producing an electric power generating element using volcanic ash according to claim 1, wherein said electric power generating element is a hermetically sealed structure enclosed with an insulation container with the cathode and anode located at both ends thereof.

14. The method of producing an electric power generating element using volcanic ash according to claim 13, wherein said sealed structure is a moisture-proof one to prevent permeation of water and gas.

15. An electric cell utilizing volcanic ash comprising a plurality of electric power generating elements combined properly by electrical wiring to configure a group of electric power generating elements which is adapted to required voltage and current capacity, and a terminal board for external connection provided for connecting said group to an external load, wherein each of said electric-power generating elements is composed of a static electricity generating member formed out of volcanic ash dampened with a minus ion aqueous solution and an anode and a cathode sandwiching said member, or wherein said electricity generating member is formed out of volcanic ash mixed with minerals other than the volcanic ash, or wherein an electrically conductive powder containing water intervenes between said anode and static electricity generating member, or wherein each of said electric power generating elements comprises a hermetically sealed structure enclosed with an insulation container with the cathode and anode located at both ends thereof.

16. The electric cell utilizing volcanic ash according to claim 15, wherein said group of electric power generating elements is formed by stacking each element connected with each other with wiring, and on the uppermost and lowermost element of the stacked elements connected in series are provided terminal boards for connecting them to an external load.

17. The electric cell utilizing volcanic ash according to claim 15, wherein said group of electric power generating elements is composed of a plurality of the elements in series connection, the elements contacting with each other successively at the different polarity electrode of each element, and terminal boards for external connection are provided to be connected with the ends of the cathode and anode not connected with each other.

18. The electric cell utilizing volcanic ash according to claim 15, wherein said group of electric power generating elements is composed of a plurality of the elements in parallel connection, connecting the electrodes of the same polarity, and terminal boards for external connection are provided to be connected with each end of connecting means connecting the electrodes of the same polarity.

19. The electric cell utilizing volcanic ash according to claim 15, wherein said group of electric power generating elements is composed of a plurality of the elements in series and parallel connection, and terminal boards for external connection are provided to be connected with the beginning and end of the connecting means.

20. An electric cell utilizing volcanic ash comprising an insulation container board having small holes, electric power generating elements, and terminal boards for external connection, said electric power generating elements being encapsulated into the small holes of said insulation container board to compose an electric power generating board, a group of anodes and a group of cathodes that are exposed on the upper and lower surface of the electric power generating board being connected together or separately to said terminal boards for external connection.

21. The electric cell utilizing volcanic ash according to claim 20, wherein volcanic ash containing minus ion aqueous solution and electrically conductive powder containing water are filled into the small holes of said container board to form an electric power generating board baying unit layer cells, and an anode board having anodes and a cathode board having cathodes are attached onto both surfaces of the board to hermetically seal said cells.

22. The electric cell utilizing volcanic ash according to claim 20, wherein volcanic ash containing minus ion aqueous solution and electrically conductive powder containing water are filled into the small holes of said container board, an anode board having anodes and a cathode board having cathodes are attached onto both surface of the board to hermetically seal said cells and form an electric power generating board having unit layer cells, each cathode and anode having a protrusion and recess to be fitted when said boards are stacked, and a plurality o the electric power generating boards having unit layer cells are stacked to compose the electric power generating board.

23. The electric cell utilizing volcanic ash according to claim 20, wherein said container board has a thickness, which is a times the thickness of an electric power generating board having unit layer cells minus the thickness of a cathode plate and an anode plate to be attached onto both surfaces of the container board, and provided with a plurality of small holes arranged in proper alignment, the electric power generating board is composed so that n pieces of electric power generating elements are inserted in series connection into each of the small holes, a cathode plate and an anode plate are attached onto both surfaces of the board to hermetically seal the n-layer cells, the insertion of said electric power generating elements being carried out in such a manner that n laminated plates having a cathode plate, a layer of volcanic ash containing minus ion aqueous solution coated on said cathode plate, a layer of electrically conductive powder coated on said layer of volcanic ash containing minus ion aqueous solution, and an anode plate attached onto the layer of electrically conductive powder, are prepared, one of the plate is laid on said container board and punched to insert the punched pieces into the small holes of the container board, this operation being repeated for another laminated plate until laminated plate are punched to allow n layer of cells to be formed in each of the small holes of the board, and a cathode plate and an anode plate are attached onto both surfaces of the board to hermetically seal the cells.

24. The electric cell utilizing volcanic ash according to claim 20, wherein volcanic ash containing minus ion aqueous solution and electrically conductive powder containing water are filled into the small boles of said container board, a cathode is attached onto the upper end of each of the small holes, and an anode is attached onto the lower end of each of the small boles to hermetically seal the hole.

25. An apparatus for controlling electric cells utilizing volcanic ash in an electric energy supply system comprising a plurality of groups of cells, each cell being composed of a static electricity generating member formed out of volcanic ash dampened with a minus ion aqueous solution and an anode and a cathode sandwich said member, and a switching means to switch between each load and said cell groups, wherein each time when the output voltage of a live cell group decreases below the prescribed voltage, switching is done to another cell group to maintain stable supply of electric energy to the load side, and the number of said cell groups is determined so that the period can be secured for the recovery of electromotive force of the cell group reduced in voltage and switched off.

26. The apparatus for controlling electric cells utilizing volcanic ash according to claim 25, wherein said switching means switches on and off said plurality of cell groups periodically and sequentially without detecting the output voltage of the live group of cells.

27. The apparatus for controlling electric cells utilizing volcanic ash according to claim 25, wherein the on-off switching of said plurality of groups of cells is conducted by activating a signal generator through a clock pulse sent from an oscillator provided separately.

28. An apparatus for controlling electric cells utilizing volcanic ash in an output circuit having a switching control apparatus for switching a plurality of cell groups of at least three or more groups, each cell being composed of a static electricity generating member formed out of fine, hollow, sphere-like particles of volcanic ash dampened with a minus ion aqueous solution, electrically conductive powder containing water, and an anode and a cathode sandwiching said member, wherein a charging-discharging circuit comprising a condenser is provided at the output terminal of said output circuit in order to charge and discharge in accordance with the condition of load, each cell group is switched with a load switching signal to be connected to the load to output electric energy in a sequential pulse at a definite time interval via a switching circuit board.

29. The apparatus for controlling electric cells utilizing volcanic ash according to claim 28, wherein said load switching signal is variable in its pulse width.

30. The apparatus for controlling electric cells utilizing volcanic ash according to claim 28, wherein said switching circuit board uses a plurality of groups of cells utilizing volcanic ash, and said groups of cells are switched by switching gate signals.
